(19) United States
(12) Patent Application Publication
(10) Pub. No.: US 2026/0231061 A1
(43) Pub. Date: Aug. 6, 2026

(54) NEIGHBORING CELL MEASUREMENT CONFIGURATIONS IN NON-TERRESTRIAL NETWORKS

(71) Applicant: QUALCOMM Incorporated, San Diego, CA (US)

(72) Inventors: Jae Ho RYU, San Diego, CA (US); Changhwan PARK, San Diego, CA (US); Hari SANKAR, San Diego, CA (US)

(21) Appl. No.: 19/044,361

(22) Filed: Feb. 3, 2025

(51) Int. Cl. H04W 56/00; H04W 24/10; H04W 84/06

(52) U.S. Cl. CPC H04W 56/0015; H04W 24/10; H04W 84/06

(57) ABSTRACT

Methods, systems, and devices for wireless communication are described. The method may include receiving first information indicative of a set of multiple measurement timing configuration windows (SMTC windows) for measurement of neighbor cell synchronization signal blocks (SSBs), where the neighbor cell SSBs are associated with a set of multiple SSB groups, and where the set of multiple SSB groups is associated with one or more non-terrestrial network (NTN) network entities. The method may include measuring, during a first SMTC window, a first SSB, where the first SSB is associated with a first SSB group of the set of multiple SSB groups, and measuring, during a second SMTC window, a second SSB, where the second SMTC window is temporally offset from the first SMTC window, and where the second SSB is associated with a second SSB group of the set of multiple SSB groups.

### INTRODUCTION

The following relates to wireless communication, including neighboring cell measurement configurations in non-terrestrial networks. Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method of wireless communication performed by a first network entity is described. The method may include receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities, measuring, during a first measurement timing configuration window of the set of multiple measurement timing configuration windows, a first SSB in accordance with the first information, where the first SSB is associated with a first SSB group of the set of multiple SSB groups, and measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

A first network entity for wireless communication is described. The first network entity may include a processing system configured to receive first information indicative of a set of multiple measurement timing configuration windows for measurement of neighbor cell SSBs, where the neighbor cell SSBs are collectively associated with a set of multiple SSB groups, and where the set of multiple SSB groups is collectively associated with one or more NTN network entities, measure, during a first measurement timing configuration window of the set of multiple measurement timing configuration windows, a first SSB in accordance with the first information, where the first SSB is associated with a first SSB group of the set of multiple SSB groups, and measure, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

Another first network entity for wireless communication is described. The first network entity may include means for receiving first information indicative of a set of multiple measurement timing configuration windows for measurement of neighbor cell SSBs, where the neighbor cell SSBs are collectively associated with a set of multiple SSB groups, and where the set of multiple SSB groups is collectively associated with one or more NTN network entities, means for measuring, during a first measurement timing configuration window of the set of multiple measurement timing configuration windows, a first SSB in accordance with the first information, where the first SSB is associated with a first SSB group of the set of multiple SSB groups, and means for measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

A non-transitory computer-readable medium is described. The non-transitory computer-ready medium may have code for wireless communication stored thereon that, when executed by a network first network entity, causes the first network entity to receive first information indicative of a set of multiple measurement timing configuration windows for measurement of neighbor cell SSBs, where the neighbor cell SSBs are collectively associated with a set of multiple SSB groups, and where the set of multiple SSB groups is collectively associated with one or more NTN network entities, measure, during a first measurement timing configuration window of the set of multiple measurement timing configuration windows, a first SSB in accordance with the first information, where the first SSB is associated with a first SSB group of the set of multiple SSB groups, and measure, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

In some examples of the method, first network entities, and non-transitory computer-readable medium described herein, the first information includes a common indication that indicates the set of multiple measurement timing configuration windows.

Some examples of the method, first network entities, and non-transitory computer-readable medium described herein may further include operations, features, means, or instructions for receiving an indication of a periodicity of SSB transmission, where the periodicity may be applicable to periodic transmissions of the first SSB and periodic transmissions of the second SSB, where the periodic transmissions of the second SSB may be temporally offset from the periodic transmissions of the first SSB, where measuring the first SSB includes, measuring the first SSB during a first subset of measurement timing configuration windows of the set of multiple measurement timing configuration windows based on the periodicity, where the first subset of measurement timing configuration windows includes the first measurement timing configuration window, and where measuring the SSB includes, and measuring the second SSB during a second subset of measurement timing configuration windows of the set of multiple measurement timing configuration windows based on the periodicity, where the second subset of measurement timing configuration windows includes the second measurement timing configuration window.

In some examples of the method, first network entities, and non-transitory computer-readable medium described herein, receiving the indication of the periodicity may include operations, features, means, or instructions for receiving the indication as part of the first information that may be indicative of the set of multiple measurement timing configuration windows.

In some examples of the method, first network entities, and non-transitory computer-readable medium described herein, receiving the indication of the periodicity may include operations, features, means, or instructions for receiving mobility configuration information that includes the indication of the periodicity.

In some examples of the method, first network entities, and non-transitory computer-readable medium described herein, the indication of the periodicity may be a parameter in a measurement object information element (IE), in an intra-frequency cell reselection information field in a system information block of a first type, or in an inter-frequency carrier frequency information field in a system information block of a second type.

In some examples of the method, first network entities, and non-transitory computer-readable medium described herein, a first indication of a first subset of measurement timing configuration windows of the set of multiple measurement timing configuration windows, where the first subset of measurement timing configuration windows includes the first measurement timing configuration window and may be associated with the first SSB group and a second indication of a second subset of measurement timing configuration windows of the set of multiple measurement timing configuration windows, where the second subset of measurement timing configuration windows includes the second measurement timing configuration window and may be associated with the second SSB group.

In some examples of the method, first network entities, and non-transitory computer-readable medium described herein, a first periodicity of the first subset of measurement timing configuration windows may be equal to a first periodicity of first SSBs associated with the first SSB group, and where a second periodicity of the second subset of measurement timing configuration windows may be equal to a second periodicity of second SSBs associated with the second SSB group.

In some examples of the method, first network entities, and non-transitory computer-readable medium described herein, the first subset of measurement timing configuration windows may be associated with the first SSB group and a first NTN network entity of the one or more NTN network entities and the second subset of measurement timing configuration windows may be associated with the second SSB group and a second NTN network entity of the one or more NTN network entities.

In some examples of the method, first network entities, and non-transitory computer-readable medium described herein, the first subset of measurement timing configuration windows may be associated with the first SSB group and a first NTN network entity of the one or more NTN network entities, and where the second subset of measurement timing configuration windows may be associated with the second SSB group and the first NTN network entity.

Some examples of the method, first network entities, and non-transitory computer-readable medium described herein may further include operations, features, means, or instructions for transmitting an indication of a maximum quantity of different subsets of measurement timing configuration windows that the first network entity may be capable of supporting for an NTN network entity.

Some examples of the method, first network entities, and non-transitory computer-readable medium described herein may further include operations, features, means, or instructions for receiving second information indicative of a set of multiple measurement gaps for inter-frequency measurement of neighbor cells of a first NTN network entity, where each measurement timing configuration window of the set of multiple measurement timing configuration windows at least partially overlaps with a respective measurement gap of the set of multiple measurement gaps.

In some examples of the method, first network entities, and non-transitory computer-readable medium described herein, the second information includes a common indication of the set of multiple measurement gaps for inter-frequency measurement of neighbor cells of the first NTN network entity, and where the set of multiple measurement gaps indicated by the common indication includes a first measurement gap that overlaps with the first measurement timing configuration window and a second measurement gap that overlaps with the second measurement timing configuration window.

In some examples of the method, first network entities, and non-transitory computer-readable medium described herein, a first indication of a first subset of measurement gaps of the set of multiple measurement gaps for inter-frequency measurement of neighbor cells of the first NTN network entity, where the first subset of measurement gaps includes a first measurement gap that overlaps with the first measurement timing configuration window and a second indication of a second subset of measurement gaps of the set of multiple measurement gaps for inter-frequency measurement of neighbor cells of the first NTN network entity, where the second subset of measurement gaps includes a second measurement gap that overlaps with the second measurement timing configuration window.

Some examples of the method, first network entities, and non-transitory computer-readable medium described herein may further include operations, features, means, or instructions for transmitting an indication of a maximum quantity of different subsets of measurement gaps that the first network entity may be capable of supporting for an NTN network entity.

A method of wireless communication performed a first network entity is described. The method may include transmitting, via a serving cell, first information indicative of a set of multiple measurement timing configuration windows for measurement, by a second network entity, of neighbor cell SSBs that are collectively associated with a set of multiple SSB groups, where the set of multiple SSB groups is collectively associated with one or more NTN network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window and receiving, via the serving cell, measurement information that is based on at least one measurement of the first SSB or the second SSB.

A first network entity for wireless communication is described. The first network entity may include a processing system configured to transmit, via a serving cell, first information indicative of a set of multiple measurement timing configuration windows for measurement, by a second network entity, of neighbor cell SSBs that are collectively associated with a set of multiple SSB groups, where the set of multiple SSB groups is collectively associated with one or more NTN network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window and receive, via the serving cell, measurement information that is based on at least one measurement of the first SSB or the second SSB.

Another first network entity for wireless communication is described. The first network entity may include means for transmitting, via a serving cell, first information indicative of a set of multiple measurement timing configuration windows for measurement, by a second network entity, of neighbor cell SSBs that are collectively associated with a set of multiple SSB groups, where the set of multiple SSB groups is collectively associated with one or more NTN network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window and means for receiving, via the serving cell, measurement information that is based on at least one measurement of the first SSB or the second SSB.

A non-transitory computer-readable medium is described. The non-transitory computer-readable medium may have code for wireless communication stored thereon that, when executed by a network first network entity, causes the first network entity to transmit, via a serving cell, first information indicative of a set of multiple measurement timing configuration windows for measurement, by a second network entity, of neighbor cell SSBs that are collectively associated with a set of multiple SSB groups, where the set of multiple SSB groups is collectively associated with one or more NTN network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window and receive, via the serving cell, measurement information that is based on at least one measurement of the first SSB or the second SSB.

In some examples of the method, first network entities, and non-transitory computer-readable medium described herein, the first information includes a common indication that indicates the set of multiple measurement timing configuration windows.

Some examples of the method, first network entities, and non-transitory computer-readable medium described herein may further include operations, features, means, or instructions for transmitting an indication of a periodicity of SSB transmission, where the periodicity may be applicable to periodic transmissions of the first SSB and periodic transmissions of the second SSB, and where the periodic transmissions of the second SSB may be temporally offset from the periodic transmissions of the first SSB.

In some examples of the method, first network entities, and non-transitory computer-readable medium described herein, transmitting the indication of the periodicity may include operations, features, means, or instructions for transmitting the indication as part of the first information that may be indicative of the set of multiple measurement timing configuration windows.

In some examples of the method, first network entities, and non-transitory computer-readable medium described herein, transmitting the indication of the periodicity may include operations, features, means, or instructions for transmitting mobility configuration information that includes the indication of the periodicity.

In some examples of the method, first network entities, and non-transitory computer-readable medium described herein, the indication of the periodicity may be a parameter in a measurement object IE, in an intra-frequency cell reselection information field in a system information block of a first type, or in an inter-frequency carrier frequency information field in a system information block of a second type.

In some examples of the method, first network entities, and non-transitory computer-readable medium described herein, a first indication of a first subset of measurement timing configuration windows of the set of multiple measurement timing configuration windows, where the first subset of measurement timing configuration windows includes the first measurement timing configuration window and may be associated with the first SSB group and a second indication of a second subset of measurement timing configuration windows of the set of multiple measurement timing configuration windows, where the second subset of measurement timing configuration windows includes the second measurement timing configuration window and may be associated with the second SSB group.

In some examples of the method, first network entities, and non-transitory computer-readable medium described herein, a first periodicity of the first subset of measurement timing configuration windows may be equal to a first periodicity of first SSBs associated with the first SSB group, and where a second periodicity of the second subset of measurement timing configuration windows may be equal to a second periodicity of second SSBs associated with the second SSB group.

In some examples of the method, first network entities, and non-transitory computer-readable medium described herein, the first subset of measurement timing configuration windows may be associated with the first SSB group and a first NTN network entity of the one or more NTN network entities and the second subset of measurement timing configuration windows may be associated with the second SSB group and a second NTN network entity of the one or more NTN network entities.

In some examples of the method, first network entities, and non-transitory computer-readable medium described herein, the first subset of measurement timing configuration windows may be associated with the first SSB group and a first NTN network entity of the one or more NTN network entities, and where the second subset of measurement timing configuration windows may be associated with the second SSB group and the first NTN network entity.

Some examples of the method, first network entities, and non-transitory computer-readable medium described herein may further include operations, features, means, or instructions for receiving an indication of a maximum quantity of different subsets of measurement timing configuration windows that the second network entity may be capable of supporting for an NTN network entity.

Some examples of the method, first network entities, and non-transitory computer-readable medium described herein may further include operations, features, means, or instructions for transmit second information indicative of a set of multiple measurement gaps for inter-frequency measurement of neighbor cells of a first NTN network entity, where each measurement timing configuration window of the set of multiple measurement timing configuration windows at least partially overlaps with a respective measurement gap of the set of multiple measurement gaps.

In some examples of the method, first network entities, and non-transitory computer-readable medium described herein, a common indication of the set of multiple measurement gaps for inter-frequency measurement of neighbor cells, where the set of multiple measurement gaps includes a first measurement gap that overlaps with the first measurement timing configuration window and a second measurement gap that overlaps with the second measurement timing configuration window.

In some examples of the method, first network entities, and non-transitory computer-readable medium described herein, a first indication of a first subset of measurement gaps of the set of multiple measurement gaps for inter-frequency measurement of neighbor cells, where the first subset of measurement gaps includes a first measurement gap that overlaps with the first measurement timing configuration window and a second indication of a second subset of measurement gaps of the set of multiple measurement gaps for inter-frequency measurement of neighbor cells, where the second subset of measurement gaps includes a second measurement gap that overlaps with the second measurement timing configuration window.

Some examples of the method, first network entities, and non-transitory computer-readable medium described herein may further include operations, features, means, or instructions for receiving an indication of a maximum quantity of different subsets of measurement gaps that the second network entity may be capable of supporting for an NTN network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communication system that supports neighboring cell measurement configurations in non-terrestrial networks in accordance with one or more aspects of the present disclosure.

FIG. 2 shows an example of a wireless communication system that supports neighboring cell measurement configurations in non-terrestrial networks in accordance with one or more aspects of the present disclosure.

FIG. 3 shows an example of a measurement configuration that supports neighboring cell measurement configurations in non-terrestrial networks in accordance with one or more aspects of the present disclosure.

FIG. 4 shows an example of a measurement configuration that supports neighboring cell measurement configurations in non-terrestrial networks in accordance with one or more aspects of the present disclosure.

FIG. 5 shows an example of a measurement configuration that supports neighboring cell measurement configurations in non-terrestrial networks in accordance with one or more aspects of the present disclosure.

FIG. 6 shows an example of a process flow that supports neighboring cell measurement configurations in non-terrestrial networks in accordance with one or more aspects of the present disclosure.

FIGS. 7 and 8 show block diagrams of devices that support neighboring cell measurement configurations in non-terrestrial networks in accordance with one or more aspects of the present disclosure.

FIG. 9 shows a block diagram of a communications manager that supports neighboring cell measurement configurations in non-terrestrial networks in accordance with one or more aspects of the present disclosure.

FIG. 10 shows a diagram of a system including a device that supports neighboring cell measurement configurations in non-terrestrial networks in accordance with one or more aspects of the present disclosure.

FIGS. 11 and 12 show block diagrams of devices that support neighboring cell measurement configurations in non-terrestrial networks in accordance with one or more aspects of the present disclosure.

FIG. 13 shows a block diagram of a communications manager that supports neighboring cell measurement configurations in non-terrestrial networks in accordance with one or more aspects of the present disclosure.

FIG. 14 shows a diagram of a system including a device that supports neighboring cell measurement configurations in non-terrestrial networks in accordance with one or more aspects of the present disclosure.

FIGS. 15 through 17 show flowcharts illustrating methods that support neighboring cell measurement configurations in non-terrestrial networks in accordance with one or more aspects of the present disclosure.

### DETAILED DESCRIPTION

Some wireless communication systems may support communications between satellite network entities (e.g., non-terrestrial network (NTN) network entities) and user equipments (UEs). In some cases, these NTN network entities may utilize many (e.g., hundreds) of downlink beams to support communications over a wide coverage area. However, utilization of many or all of the supported beams may be associated with significant power overhead. More particularly, the NTN network entities may not be equipped with enough power budget to support communications of many beams over an extended period of time. As such, the NTN network entities may utilize beam-hopping schemes, whereby a first subset of cells, supported by a first subset of beams, are serviced during a first duration, and a second subset of cells, supported by a second subset of beams, are serviced during a second duration.

However, some types of signals are channels (e.g., broadcast channels, such as synchronization signal blocks (SSBs) and type 1 system information (SIB1), among other information) may be transmitted on a periodic basis to support UE connectivity. However, supporting such periodic transmissions in cells may utilize significant portion of the transmission/power overhead of the NTN network entities supporting the cells. Additionally, when some cells are not being serviced during a duration, due to a NTN network entity beam hopping scheme, such signals may not be transmitted. Such scenarios may lead to UEs losing connectivity or not being able to establish links within a cell. Accordingly, some wireless communication systems may implement extensions in the periodicity of periodic signal transmissions to support reduced power overhead and beam-hopping schemes.

Moreover, wireless communication systems may support measurements (e.g., layer 3 (L3) measurements) to support mobility and handover procedures for UEs. These measurements may be implemented using measurement gaps (e.g., for inter-frequency measurements) and SSB-based radio resource management (RRM) measurement timing configuration (SMTC) windows. During these measurement gaps and/or SMTC windows, the UEs may be configured to measure neighbor cell signals, such as SSBs. However, as NTN network entities may implement beam-hopping techniques, whereby some cells (e.g., neighbor cells) may not be transmitting during a duration, some neighbor cells may not be available for measurement, which may impact the availability of neighbor cells for UEs for mobility and/or handover.

Techniques described herein support alignment of SMTC windows and/or measurement gap with neighbor cell SSB transmissions such as to support UE mobility and handover, while also allowing extension in SSB periodicity for cells for beam-hopping (e.g., such that the SSB transmissions are less frequent), which may support reduced power overhead at NTN network entities. Thus, according to techniques described herein, a UE may be configured with multiple SMTC windows for measurement of neighbor cell SSBs, where neighbor cell SSBs may be configured with multiple SSB groups (e.g., cell groups). The UE may measure neighbor cell SSBs during one or more SMTC windows. The SMTC windows for respective SSB groups may be temporally offset from one another such as to support the SSB periodicity in each SSB group. SMTC windows for each respective SSB group may be configured using a common configuration or respective SMTC configurations. Measurement gaps may similarly configured at UEs. These and other techniques are described in further detail with respect to the figures.

Aspects of the disclosure are initially described in the context of wireless communication systems. Aspects of the disclosure are further described with respect to a wireless communication system illustrating a NTN network entity and measurement configurations, various measurement configurations, and a process flow. Aspects of the disclosure are further illustrated by and described with reference to apparatus diagrams, system diagrams, and flowcharts that relate to neighboring cell measurement configurations in non-terrestrial networks.

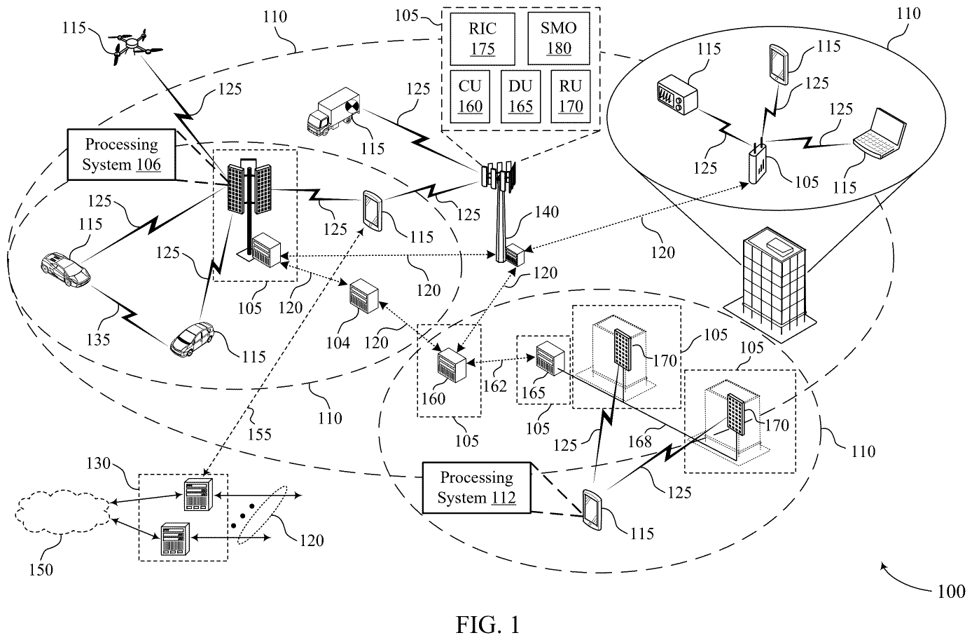

FIG. 1 shows an example of a wireless communication system 100 that supports neighboring cell measurement configurations in non-terrestrial networks in accordance with one or more aspects of the present disclosure. The wireless communication system 100 may include one or more devices, such as one or more network devices (e.g., network entities 105), one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communication system 100 (e.g., other wireless communication devices, including UEs 115 or network entities 105), as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other aspects, or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support neighboring cell measurement configurations in non-terrestrial networks as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other aspects. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other aspects, which may be implemented in various objects such as appliances, vehicles, or meters, among other aspects.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other aspects, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other aspects.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communication system 100 may include, for example, a heterogeneous network in which different types of the network entities 105 support communications for coverage areas 110 (e.g., different coverage areas) using the same or different RATs.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may support network entities 105 that are NTN network entities. These NTN network entities may support beam-hopping schemes such that a first subset of cells, supported by a first subset of beams, are serviced during a first duration, and a second subset of cells, supported by a second subset of beams, are serviced during a second duration. These techniques may support reduced power overhead at the NTN network entities. Additionally, UEs 115 may be configured with SMTC windows and/or measurement gaps that support neighbor cell SSB measurements to support handover and mobility for UEs 115. According to techniques described herein, the SMTC windows and/or measurement gaps may be aligned with the SSB periodicity of neighbor cell SSB groups. These techniques may support mobility and handover of UEs 115 while also supporting reduced resource overhead at NTN network entities (e.g., the network entities 105).

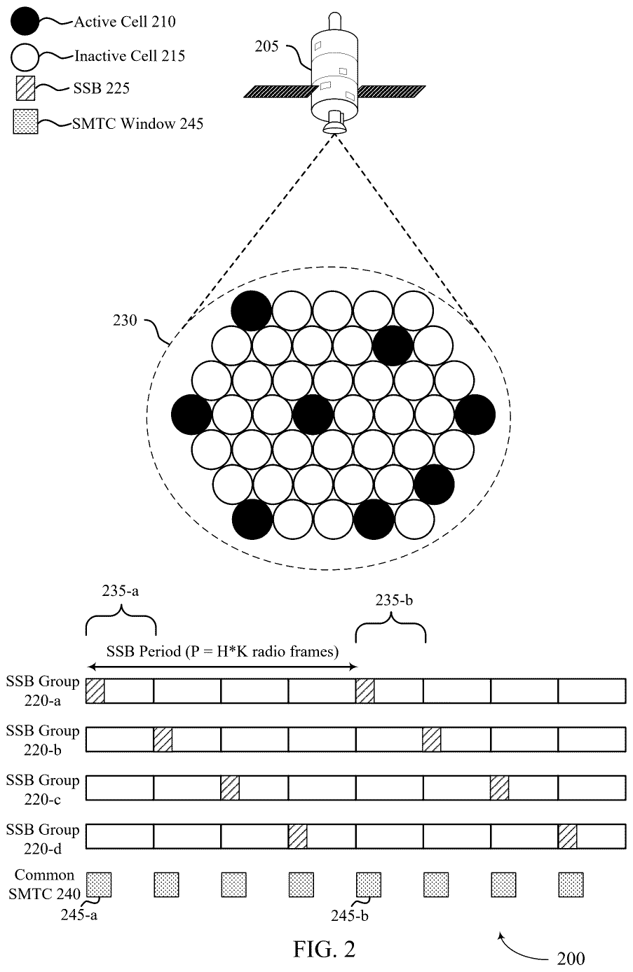

FIG. 2 shows an example of a wireless communication system 200 that supports neighboring cell measurement configurations in non-terrestrial networks in accordance with one or more aspects of the present disclosure. The wireless communication system 200 includes a NTN network entity 205, which may be an example of the network entities 105 described herein with respect to FIG. 1. The NTN network entity 205 may support communications with UEs (e.g., UEs 115 of FIG. 1) positioned within a coverage area 230 of the NTN network entity 205.

The NTN network entity 205 may support utilization of many (e.g., hundreds) of different beams. One or more beams may be utilized for communications within a cell within the coverage area 230. The quantity of simultaneously active downlink beam by the NTN network entity 205 may be limited due to constraints on, for example, a maximum aggregated effective isotropic radiated power (EIRP) and a radio-frequency chain limitation (e.g., a maximum quantity of simultaneously illuminated beams). When one or more downlink beams are not active for data transmissions, the NTN network entity 205 may transmit signals, such as SSB and SIB continuously or periodically to support UE 115 mobility and handover. However, continuous or periodic SSB/SIB1 transmission may be associated with a significant portion of overall transmission overhead by the NTN network entity 205. To support reduction in such overhead, the periodicity of SSB/SIB1 transmission may be extended relative to other implementations (e.g., terrestrial network implementations).

To support extension in in SSB/SIB1 transmission periodicity (e.g., so that there are longer gaps between each SSB/SIB1 transmission), the NTN network entity 205 may support downlink beam hopping techniques. In accordance with the downlink beam hopping techniques, various cells supported by the NTN network entity 205 may be partitioned into K SSB groups 220 (e.g., SSB group 220-a, SSB group 220-b, SSB group 220-c, and SSB group 220-d), and SSBs 225 for cells in the same SSB group are transmitted using the same timing configurations. Thus, cells within one of the SSB groups 220 may be active (e.g., transmit) during a duration, while cells not in the same SSB group may be inactive (e.g., not transmit) during the same duration. For example, active cells 210, which may be part of the SSB group 220-a, may transmit during duration 235-a and 235-b. During other durations, other cells (e.g., one or more inactive cells 215) may be activated and transmit in accordance with a configuration for another SSB group 220. During an active duration, the NTN network entity 205 may transmit using one or more beams associated with the cells within the SSB group, and other beams (e.g., associated with inactive cells 215) may not be utilized. As illustrated in FIG. 2, the cells supported by the NTN network entity 205 may be split into four groups (e.g., K=4).

The wireless communication system 200 may support L3 measurements for UE mobility and/or handover procedures. The L3 measurements may be based on measurement gap and SMTC configurations. Measurement gaps may allow UEs 115 to tune away from serving cell operations for measurements in different frequency layers (e.g., inter-frequency measurements). SMTC configurations may provide the UEs 115 with information about measurement windows to search and/or measure SSBs from neighbor cells associated with a specific frequency layer (e.g., intra-frequency measurements). In terrestrial network implementations, one frequency layer may be associated with one SMTC configuration. In NTN implementations, one frequency layer may be associated with multiple (e.g., up to four) SMTC configurations. Different SMTC windows may be used for neighbor cells served by different non-geostationary satellite orbit (NGSO) satellites and the SMTC windows may be configured with the same periodicity but multiple configurable offsets with regard to the first SMTC window. Thus, measurement gaps may be configured to overlap with a first set of SMTC windows and a second set of SMTC windows, and the second set of SMTC windows may be temporally offset from the first set of SMTC windows.

In NTN deployments, such as illustrated in FIG. 2, the NTN network entity 205 may have limited beam capabilities, as described herein. In such cases, SSB transmission for neighbor cells from the same satellite may not be guaranteed to fall within the same SMTC windows. As such, in accordance with techniques described herein, SMTC and measurement gap configurations may be enhanced to accommodate SSB transmission for NTN deployment with limited beam capability satellites.

In accordance with the technique illustrated in FIG. 2, a common SMTC configuration 240 may define a set of SMTC windows 245 based on a periodicity that allows the SMTC windows 245 to cover SSBs 225 from multiple SSB groups 220. The SSB periodicity (e.g., P=H*K radio frames) may be configured in addition to or as part of the SMTC configuration 240. For example, the SSB periodicity may be configured as a parameter in the SMTC configuration (e.g., SSB-MTC). Additionally, or alternatively, the SSB periodicity may be configured as a parameter in one or more information elements, such as MeasObjectNR, intraFreqCellReselectionInfo (SIB2) or InterFreqCarrierFreqInfo (SIB4). When a UE 115 detects/measures a neighbor cell SSB in one of the common SMTC windows, the UE should expect or assume that the same SSB is transmitted according to the configured SSB periodicity. For example, the UE 115 detects the SSB 225 in SMTC window 245-a and the SSB 225 in the SMTC window 245-b, and the UE 115 assumes that the same SSB 225 is transmitted since the SMTC windows 245-a and 245-b are positioned with respect to the configured SSB periodicity.

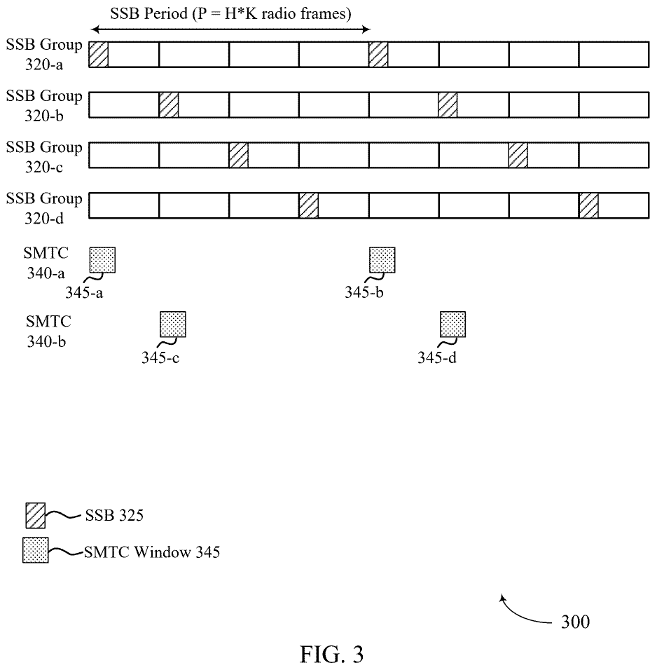

FIG. 3 shows an example of a measurement configuration 300 that supports neighboring cell measurement configurations in non-terrestrial networks in accordance with one or more aspects of the present disclosure. The measurement configuration 300 may implement or be implemented by aspects of the wireless communication system 100 of FIG. 1 and the wireless communication system 200 of FIG. 2. For example, the UEs 115 of FIG. 1 and the NTN network entity 205 of FIG. 2 may implement or support the measurement configuration 300.

As illustrated in the measurement configuration 300, cells supported by a NTN network entity are partitioned into K=4 SSB groups 320 (e.g., SSB group 320-a, SSB group 320-b, SSB group 320-c, and SSB group 320-d). SSBs 325 for the cells in the same SSB group 320 are transmitted using the same timing (e.g., in accordance with a periodicity). Rather than a common SMTC periodicity as illustrated in FIG. 2, FIG. 3 illustrates separate SMTC configurations 340 for one or more SSB groups 320, where the SMTC configurations 340 define SMTC windows 345. Thus, SMTC configuration 340-a supports SSB 325 measurements for SSB group 320-a, and SMTC configuration 340-b supports SSB 325 measurements for SSB group 320-b. Thus, during SMTC window 345-a and SMTC window 345-b, the UE 115 may measure the SSBs 225 for the SSB group 320-a. During SSB window 345-c and the SMTC window 345-d, the UE 115 may measure the SSBs 325 for SSB group 320-b. As illustrated, each SSB group 320 may not have a respective SMTC configuration 340. For example, the SSB groups 320-c and 320-d may not have a corresponding SMTC configuration, and as such, the UE 115 may not measure the neighbor cell SSBs associated with the SSB group 320-c and 320-d.

In some cases, more than one NTN network entity may support the neighbor cells and corresponding SSB groups. In such cases, one or multiple SMTC configurations 340 may be configured for each NTN network entity. Additionally, the maximum quantity of SMTC configurations 340 per NTN network entity may be based on UE capability. As such, the UE 115 may report a quantity of SMTC configurations per NTN network entity, and the UE 115 may be configured with SMTC configurations accordingly.

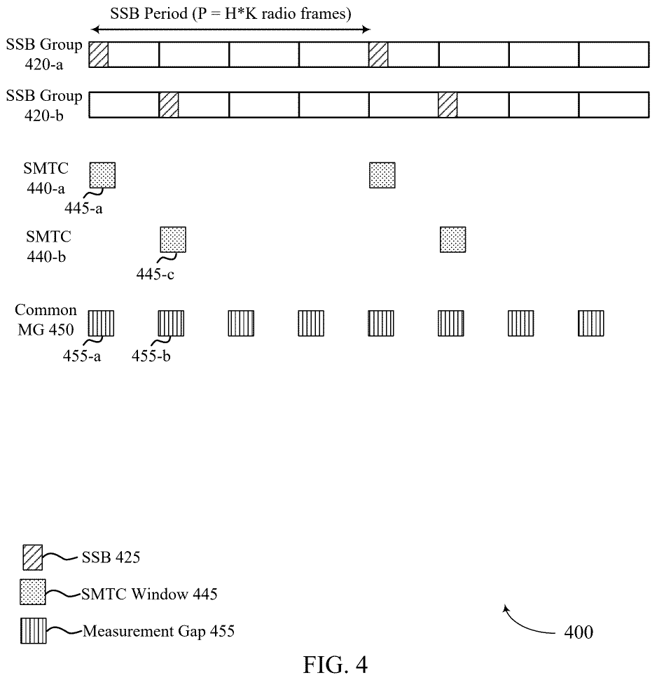

FIG. 4 shows an example of a measurement configuration 400 that supports neighboring cell measurement configurations in non-terrestrial networks in accordance with one or more aspects of the present disclosure. The measurement configuration 400 may implement or be implemented by aspects of the wireless communication system 100 of FIG. 1 and the wireless communication system 200 of FIG. 2. For example, the UEs 115 of FIG. 1 and the NTN network entity 205 of FIG. 2 may implement or support the measurement configuration 400.

As illustrated in the measurement configuration 400, cells supported by a NTN network entity are partitioned into K=2 SSB groups 420 (e.g., SSB group 420-a and SSB group 420-b). SSBs 425 for the cells in the same SSB group 420 are transmitted using the same timing (e.g., in accordance with a periodicity). SSB groups 420 may be associated respective SMTC configurations 440 (e.g., SMTC configuration 440-a for SSB group 420-a and SMTC configuration 440-b for SSB group 420-b), as illustrated and described with respect to FIG. 3. Additionally, or alternatively, for inter-frequency measurements for the neighbor cells from the same NTN network entity, a common measurement gap (MG) 450 can be configured to support measurements of neighbor cells from the same NTN network entity. Thus, a configuration for a periodicity, offset, and duration {periodicity, offset, duration} may define multiple measurement gaps 455 that cover the SMTC windows 445 across one or multiple SSB groups 420. If multiple SMTC windows are configured with uniform spacing to cover multiple SSB groups, the measurement gap configuration 450 may define the measurement gaps 455 that cover the SMTC occasions for the configured SMTC windows 445. As illustrated, using the common measurement gap configuration 450 may result in some measurement gaps 455 being wasted (e.g., not overlapping with a SMTC window). However, the common measurement gap configuration 450 may result in reduced configuration signaling overhead.

Thus, using these techniques, a UE may measure the SSB 425 corresponding to SSB group 420-a during measurement gap 455-a and SMTC window 445-a. Additionally, the UE 115 may measure the SSB 425 corresponding to SSB group 420-b during measurement gap 455-b and SMTC window 445-c.

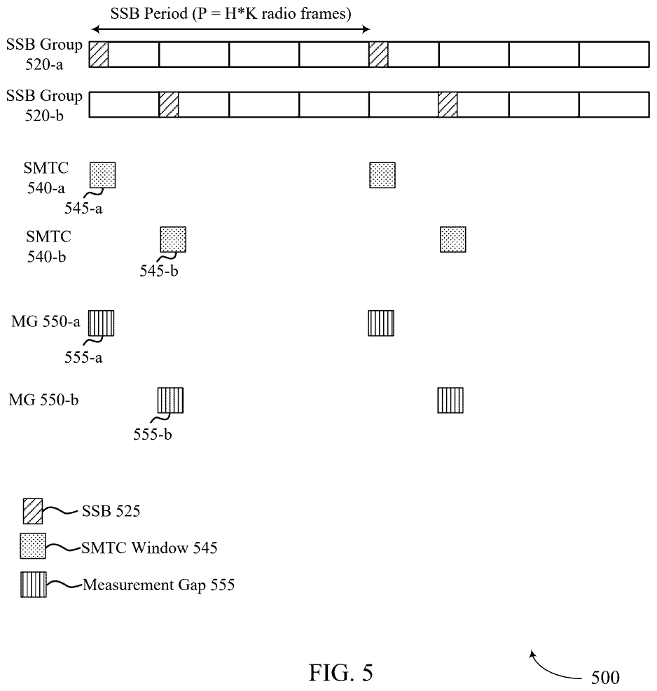

FIG. 5 shows an example of a measurement configuration 500 that supports neighboring cell measurement configurations in non-terrestrial networks in accordance with one or more aspects of the present disclosure. The measurement configuration 500 may implement or be implemented by aspects of the wireless communication system 100 of FIG. 1 and the wireless communication system 200 of FIG. 2. For example, the UEs 115 of FIG. 1 and the NTN network entity 205 of FIG. 2 may implement or support the measurement configuration 500.

As illustrated in the measurement configuration 500, cells supported by a NTN network entity are partitioned into K=2 SSB groups 520 (e.g., SSB group 520-a and SSB group 520-b). SSBs 525 for the cells in the same SSB group 520 are transmitted using the same timing (e.g., in accordance with a periodicity). SSB groups 520 may be associated respective SMTC configurations 540, as illustrated and described with respect to FIG. 3, and the respective SMTC configurations 540 may define sets of SMTC windows 545. Additionally, or alternatively, for inter-frequency measurements for neighbor cells of one or more NTN network entities, the UE may be configured with multiple measurement gap configurations 550, where each measurement gap configuration 550 corresponds to a respective SMTC configuration 540. Thus, a {periodicity, offset, duration) for one measurement gap configuration 550 may be configured to support one SMTC configuration 540 associated with SSB 525 transmission for one SSB group 520 (e.g. SMTC configuration 540-a for SSB group 520-a and SMTC configuration 540-b for SSB group 520-b). As illustrated, measurement gap configuration 550-a defines measurement gaps 555 that correspond to SSB 525 transmissions in SSB group 520-a, and measurement gap configuration 550-b defines measurement gaps 555 that correspond to SSB 525 transmissions in SSB group 520-b. In some cases, the maximum quantity of measurement gap configurations 550 that be configured for a NTN network entity may be configured in accordance with the UE capability. As such, the UE 115 may transmit a UE capability report that indicates the maximum quantity of measurement gap configurations 550 for a NTN network entity.

Thus, in accordance with the measurement configuration 500, the UE 115 may measure the SSB 525 during the measurement gap 555-a and the SMTC window 545-a associated with SSB group 520-a. Additionally, the UE 115 may measure the SSB 525 during the measurement gap 555-b and the SMTC window 545-b corresponding to SSB group 520-b.

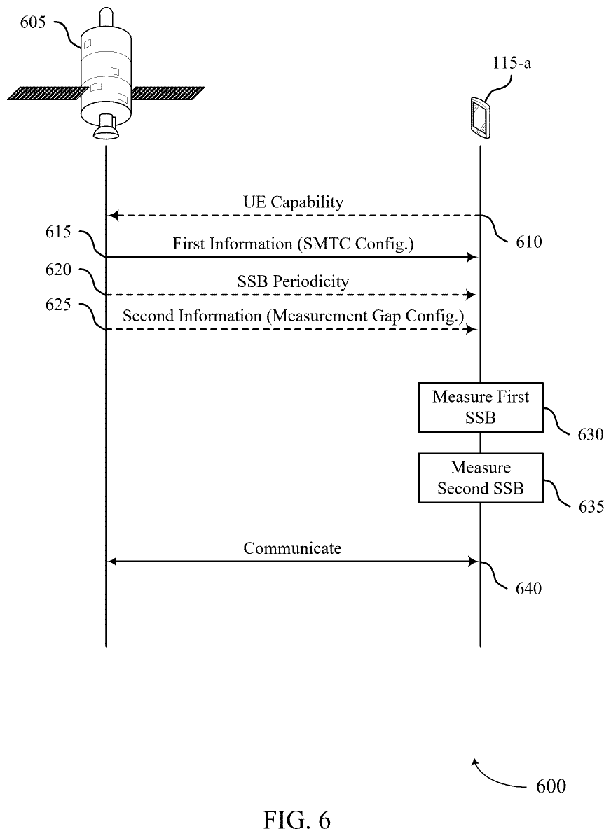

FIG. 6 shows an example of a process flow 600 that supports neighboring cell measurement configurations in non-terrestrial networks in accordance with one or more aspects of the present disclosure. The process flow 600 includes a NTN network entity 605 and a UE 115-a, which may be examples of the NTN network entity 205 and the UEs 115 as described herein with respect to FIGS. 1 and 2. Alternative examples of the following may be implemented, where some steps are performed in a different order than described or are not performed at all. In some cases, steps may include additional features not mentioned below, or further steps may be added. Although the UE 115-a and the NTN network entity 605 are shown performing the operations of the process flow 600, some aspects of some operations may also be performed by one or more other wireless devices. In some cases, the process flow 600 may include more than one NTN network entity 605.

At 610, the UE 115-a may transmit a UE capability message. The UE capability message may indicate a maximum quantity of different subsets of measurement timing configuration windows that the UE 115-a is capable of supporting for an NTN network entity. Additionally, or alternatively, the UE capability message may indicate a maximum quantity of different subsets of measurement gaps that the UE 115-a is capable of supporting for an NTN network entity.

At 615, the UE 115-a may receive first information indicative of multiple measurement timing configuration windows (e.g., SMTC window) for measurement of neighbor cell synchronization signal blocks (SSBs). The neighbor cell SSBs may be collectively associated with multiple SSB groups. The multiple SSB groups may be collectively associated with one or more NTN network entities (e.g., NTN network entity 605). For example, each neighbor cell may be associated with one or more SSB groups, and each SSB group may contain one or more neighbor cells that transmit respective SSBs. Additionally, the NTN network entity 605 may support the cells in each SSB group, and/or another NTN network entity 605 may support one or more cells in one or more of the SSB groups. In some cases, the first information includes a common indication that indicates the multiple measurement timing configuration windows. In some cases, the first information includes a first indication of a first subset of measurement timing configuration windows of the multiple measurement timing configuration windows and a second indication of a second subset of measurement timing configuration windows. In some cases, the first subset of measurement timing configuration windows is associated with the first SSB group and a first NTN network entity of the one or more NTN network entities and the second subset of measurement timing configuration windows is associated with the second SSB group and a second NTN network entity of the one or more NTN network entities. Additionally, or alternatively, the first subset of measurement timing configuration windows is associated with the first SSB group and a first NTN network entity of the one or more NTN network entities, and wherein the second subset of measurement timing configuration windows is associated with the second SSB group and the first NTN network entity.

At 620, the UE 115-a may receive an indication of a periodicity of SSB transmission. The periodicity may be applicable to periodic transmissions of a first SSB (e.g., of a first SSB group) and periodic transmissions of a second SSB (e.g., of a second SSB group). The periodic transmissions of the second SSB may be temporally offset from the periodic transmissions of the first SSB. The periodicity of SSB transmissions may be received as part of the first information that is indicative of the multiple measurement timing configuration windows. Additionally, or alternatively, the periodicity of SSB transmissions may be received in mobility configuration information, such as a parameter in a measurement object information element (IE) (e.g., MeasObjectNR), in an intra-frequency cell reselection information field (e.g., intraFreqCellReselectionInfo) in a system information block of a first type (SIB2), or in an inter-frequency carrier frequency information field (e.g., InterFreqCarrierFreqInfo) in a system information block of a second type (SIB4).

At 625, the UE 115-a may receive second information indicative of multiple measurement gaps for inter-frequency measurement of neighbor cells of a first NTN network entity (e.g., the NTN network entity 605). Each measurement timing configuration window of the multiple measurement timing configuration windows may at least partially overlap with a respective measurement gap of the multiple measurement gaps. In some examples, the second information includes a common indication of the multiple measurement gaps for inter-frequency measurement of neighbor cells of the first NTN network entity, and the multiple measurement gaps indicated by the common indication may include a first measurement gap that overlaps with the first measurement timing configuration window and a second measurement gap that overlaps with the second measurement timing configuration window. In some examples, the second information includes a first indication of a first subset of measurement gaps of the multiple measurement gaps for inter-frequency measurement of neighbor cells of the first NTN network entity and a second indication of a second subset of measurement gaps of the multiple measurement gaps for inter-frequency measurement of neighbor cells of the first NTN network entity. In such cases, the first subset of measurement gaps includes a first measurement gap that overlaps with the first measurement timing configuration window, and the second subset of measurement gaps includes a second measurement gap that overlaps with the second measurement timing configuration window.

At 630, the UE 115-a may measure, during a first measurement timing configuration window of the multiple measurement timing configuration windows, a first SSB in accordance with the first information. The first SSB may be associated with a first SSB group of the multiple SSB groups.

At 635, the UE 115-a may measure, during a second measurement timing configuration window of the multiple measurement timing configuration windows, a second SSB in accordance with the first information. The second measurement timing configuration window may be temporally offset from the first measurement timing configuration window. The second SSB may be associated with a second SSB group of the multiple SSB groups. The first and second SSBs may also be measured during respective measurement gaps that overlap with the respective SMTC windows.

At 640, the UE 115-a and the NTN network entity 605 may communicate based on the SSB measurements. For example, the UE 115-a may handover to another cell and communicate in the selected cell based on the SSB measurements.

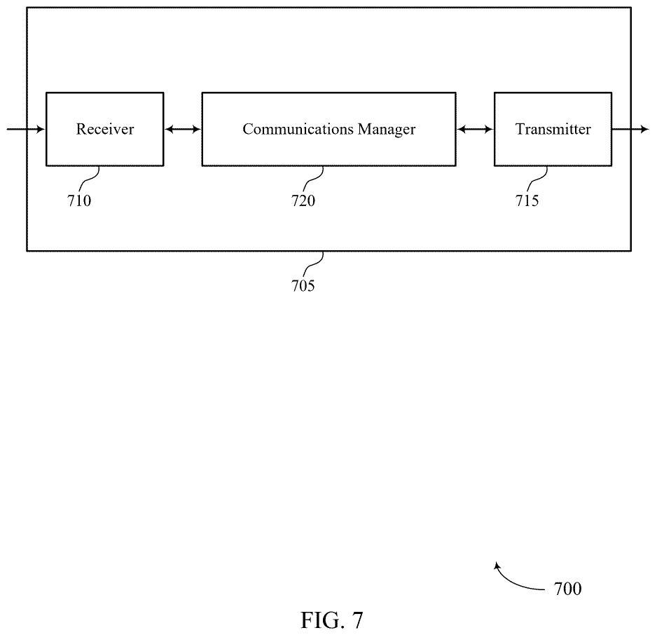

FIG. 7 shows a block diagram 700 of a device 705 that supports neighboring cell measurement configurations in non-terrestrial networks in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to neighboring cell measurement configurations in non-terrestrial networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to neighboring cell measurement configurations in non-terrestrial networks). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of neighboring cell measurement configurations in non-terrestrial networks as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities. The communications manager 720 is capable of, configured to, or operable to support a means for measuring, during a first measurement timing configuration window of the set of multiple measurement timing configuration windows, a first SSB in accordance with the first information, where the first SSB is associated with a first SSB group of the set of multiple SSB groups. The communications manager 720 is capable of, configured to, or operable to support a means for measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced power consumption and more efficient utilization of communication resources.

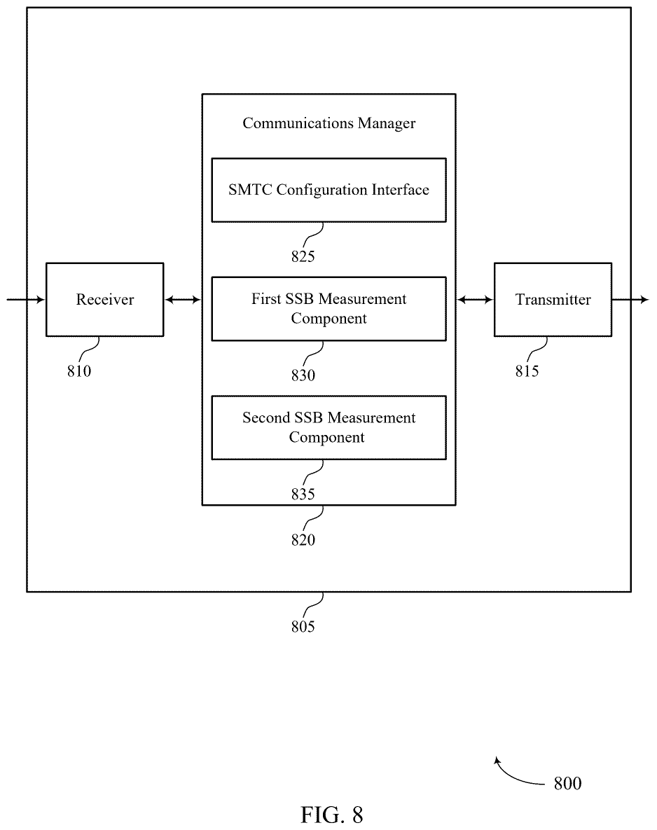

FIG. 8 shows a block diagram 800 of a device 805 that supports neighboring cell measurement configurations in non-terrestrial networks in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to neighboring cell measurement configurations in non-terrestrial networks). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to neighboring cell measurement configurations in non-terrestrial networks). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of neighboring cell measurement configurations in non-terrestrial networks as described herein. For example, the communications manager 820 may include an SMTC configuration interface 825, a first SSB measurement component 830, a second SSB measurement component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The SMTC configuration interface 825 is capable of, configured to, or operable to support a means for receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities. The first SSB measurement component 830 is capable of, configured to, or operable to support a means for measuring, during a first measurement timing configuration window of the set of multiple measurement timing configuration windows, a first SSB in accordance with the first information, where the first SSB is associated with a first SSB group of the set of multiple SSB groups. The second SSB measurement component 835 is capable of, configured to, or operable to support a means for measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

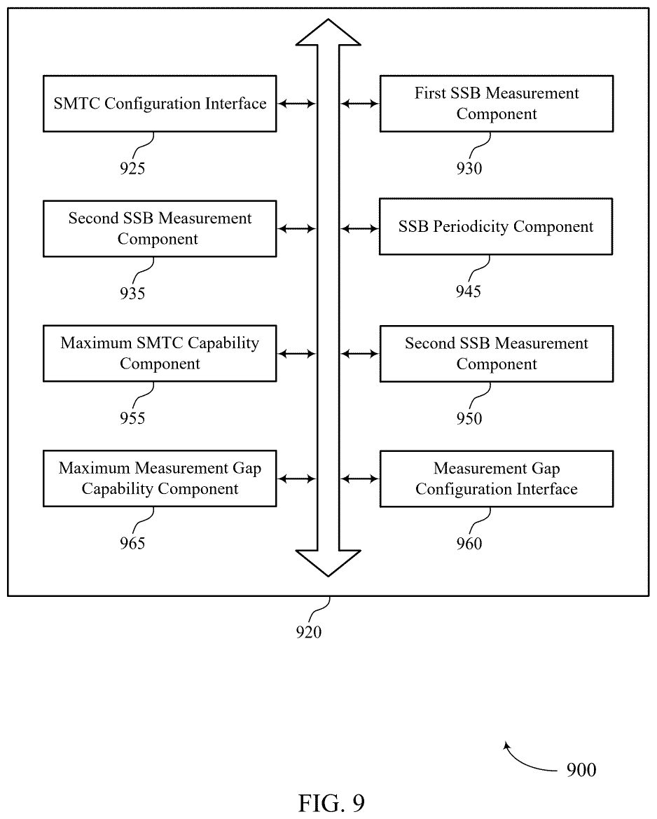

FIG. 9 shows a block diagram 900 of a communications manager 920 that supports neighboring cell measurement configurations in non-terrestrial networks in accordance with one or more aspects of the present disclosure. The communications manager 920 may be an example of aspects of a communications manager 720, a communications manager 820, or both, as described herein. The communications manager 920, or various components thereof, may be an example of means for performing various aspects of neighboring cell measurement configurations in non-terrestrial networks as described herein. For example, the communications manager 920 may include an SMTC configuration interface 925, a first SSB measurement component 930, a second SSB measurement component 935, an SSB periodicity component 945, a second SSB measurement component 950, a maximum SMTC capability component 955, a measurement gap configuration interface 960, a maximum measurement gap capability component 965, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The SMTC configuration interface 925 is capable of, configured to, or operable to support a means for receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities. The first SSB measurement component 930 is capable of, configured to, or operable to support a means for measuring, during a first measurement timing configuration window of the set of multiple measurement timing configuration windows, a first SSB in accordance with the first information, where the first SSB is associated with a first SSB group of the set of multiple SSB groups. The second SSB measurement component 935 is capable of, configured to, or operable to support a means for measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

In some examples, the first information includes a common indication that indicates the set of multiple measurement timing configuration windows.

In some examples, the communications manager 920 may receive an indication of a periodicity of SSB transmission, where the periodicity is applicable to periodic transmissions of the first SSB and periodic transmissions of the second SSB, where the periodic transmissions of the second SSB are temporally offset from the periodic transmissions of the first SSB, where measuring the first SSB includes measuring the first SSB during a first subset of measurement timing configuration windows of the plurality of measurement timing configuration windows based on the periodicity, wherein the first subset of measurement timing configuration windows includes the first measurement timing configuration window, and wherein to measure the second SSB, and where measuring the SSB includes measuring the second SSB during a second subset of measurement timing configuration windows of the plurality of measurement timing configuration windows based on the periodicity, wherein the second subset of measurement timing configuration windows includes the second measurement timing configuration window.

In some examples, to support receiving the indication of the periodicity, the SSB periodicity component 945 is capable of, configured to, or operable to support a means for receiving the indication as part of the first information that is indicative of the set of multiple measurement timing configuration windows.

In some examples, to support receiving the indication of the periodicity, the SSB periodicity component 945 is capable of, configured to, or operable to support a means for receiving mobility configuration information that includes the indication of the periodicity.

In some examples, the indication of the periodicity is a parameter in a measurement object information element (IE), in an intra-frequency cell reselection information field in a system information block of a first type, or in an inter-frequency carrier frequency information field in a system information block of a second type.

In some examples, a first indication of a first subset of measurement timing configuration windows of the set of multiple measurement timing configuration windows, where the first subset of measurement timing configuration windows includes the first measurement timing configuration window and is associated with the first SSB group. In some examples, a second indication of a second subset of measurement timing configuration windows of the set of multiple measurement timing configuration windows, where the second subset of measurement timing configuration windows includes the second measurement timing configuration window and is associated with the second SSB group.

In some examples, a first periodicity of the first subset of measurement timing configuration windows is equal to a first periodicity of first SSBs associated with the first SSB group, and where a second periodicity of the second subset of measurement timing configuration windows is equal to a second periodicity of second SSBs associated with the second SSB group.

In some examples, the first subset of measurement timing configuration windows is associated with the first SSB group and a first NTN network entity of the one or more NTN network entities and the second subset of measurement timing configuration windows is associated with the second SSB group and a second NTN network entity of the one or more NTN network entities.

In some examples, the first subset of measurement timing configuration windows is associated with the first SSB group and a first NTN network entity of the one or more NTN network entities, and where the second subset of measurement timing configuration windows is associated with the second SSB group and the first NTN network entity.

In some examples, the maximum SMTC capability component 955 is capable of, configured to, or operable to support a means for transmitting an indication of a maximum quantity of different subsets of measurement timing configuration windows that the first network entity is capable of supporting for an NTN network entity.

In some examples, the measurement gap configuration interface 960 is capable of, configured to, or operable to support a means for receiving second information indicative of a set of multiple measurement gaps for inter-frequency measurement of neighbor cells of a first NTN network entity, where each measurement timing configuration window of the set of multiple measurement timing configuration windows at least partially overlaps with a respective measurement gap of the set of multiple measurement gaps.

In some examples, the second information includes a common indication of the set of multiple measurement gaps for inter-frequency measurement of neighbor cells of the first NTN network entity, and where the set of multiple measurement gaps indicated by the common indication includes a first measurement gap that overlaps with the first measurement timing configuration window and a second measurement gap that overlaps with the second measurement timing configuration window.

In some examples, a first indication of a first subset of measurement gaps of the set of multiple measurement gaps for inter-frequency measurement of neighbor cells of the first NTN network entity, where the first subset of measurement gaps includes a first measurement gap that overlaps with the first measurement timing configuration window. In some examples, a second indication of a second subset of measurement gaps of the set of multiple measurement gaps for inter-frequency measurement of neighbor cells of the first NTN network entity, where the second subset of measurement gaps includes a second measurement gap that overlaps with the second measurement timing configuration window.

In some examples, the maximum measurement gap capability component 965 is capable of, configured to, or operable to support a means for transmitting an indication of a maximum quantity of different subsets of measurement gaps that the first network entity is capable of supporting for an NTN network entity.

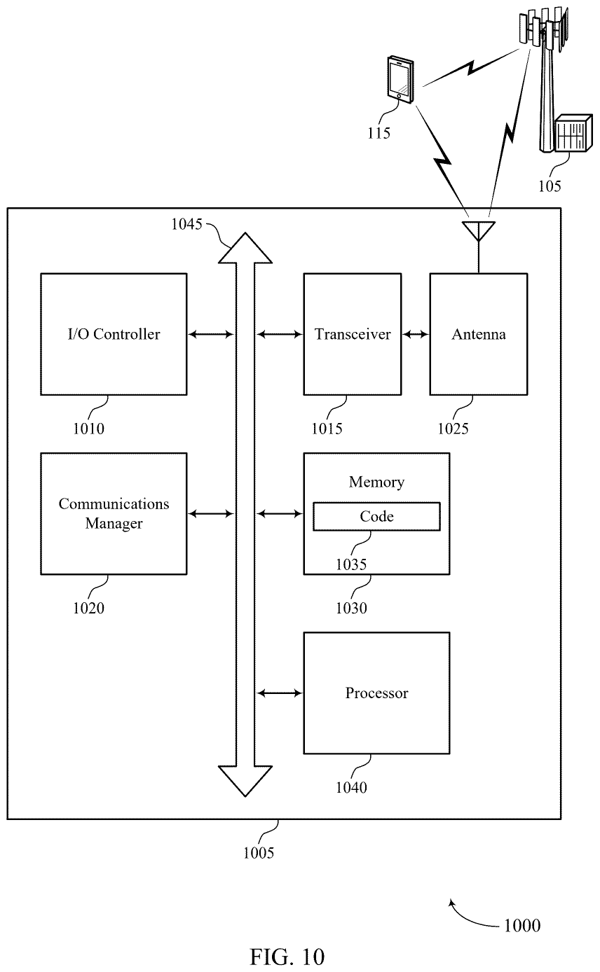

FIG. 10 shows a diagram of a system 1000 including a device 1005 that supports neighboring cell measurement configurations in non-terrestrial networks in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting neighboring cell measurement configurations in non-terrestrial networks). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities. The communications manager 1020 is capable of, configured to, or operable to support a means for measuring, during a first measurement timing configuration window of the set of multiple measurement timing configuration windows, a first SSB in accordance with the first information, where the first SSB is associated with a first SSB group of the set of multiple SSB groups. The communications manager 1020 is capable of, configured to, or operable to support a means for measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups.

By including or configuring the communications manager 1020 in accordance with examples as described herein, the device 1005 may support techniques for reduced power consumption and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of neighboring cell measurement configurations in non-terrestrial networks as described herein, or the at least one processor 1040 and the at least one memory 1030 may be otherwise configured to, individually or collectively, perform or support such operations.

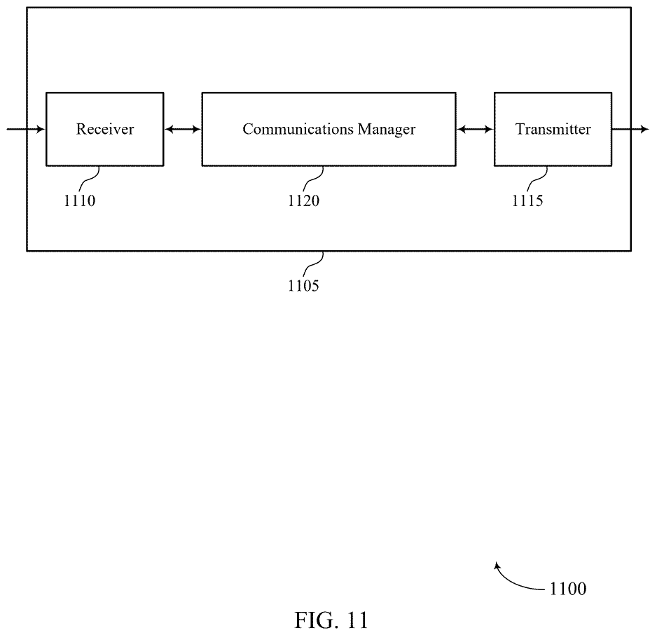

FIG. 11 shows a block diagram 1100 of a device 1105 that supports neighboring cell measurement configurations in non-terrestrial networks in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of neighboring cell measurement configurations in non-terrestrial networks as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for transmitting, via a serving cell, first information indicative of a set of multiple measurement timing configuration windows for measurement, by a second network entity, of neighbor cell synchronization signal blocks (SSBs) that are collectively associated with a set of multiple SSB groups, where the set of multiple SSB groups is collectively associated with one or more non-terrestrial network (NTN) network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window. The communications manager 1120 is capable of, configured to, or operable to support a means for receiving, via the serving cell, measurement information that is based on at least one measurement of the first SSB or the second SSB.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced power consumption and more efficient utilization of communication resources.

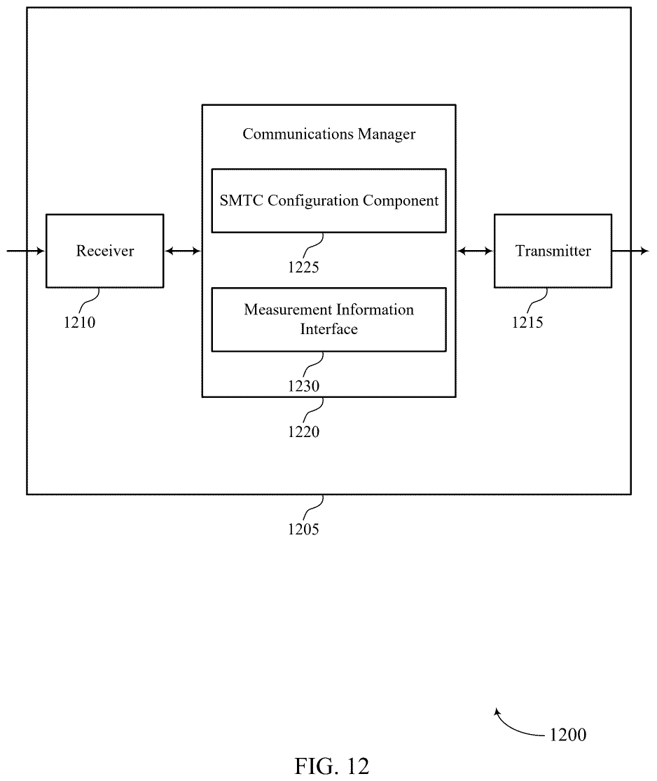

FIG. 12 shows a block diagram 1200 of a device 1205 that supports neighboring cell measurement configurations in non-terrestrial networks in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of neighboring cell measurement configurations in non-terrestrial networks as described herein. For example, the communications manager 1220 may include an SMTC configuration component 1225 a measurement information interface 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The SMTC configuration component 1225 is capable of, configured to, or operable to support a means for transmitting, via a serving cell, first information indicative of a set of multiple measurement timing configuration windows for measurement, by a second network entity, of neighbor cell synchronization signal blocks (SSBs) that are collectively associated with a set of multiple SSB groups, where the set of multiple SSB groups is collectively associated with one or more non-terrestrial network (NTN) network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window. The measurement information interface 1230 is capable of, configured to, or operable to support a means for receiving, via the serving cell, measurement information that is based on at least one measurement of the first SSB or the second SSB.

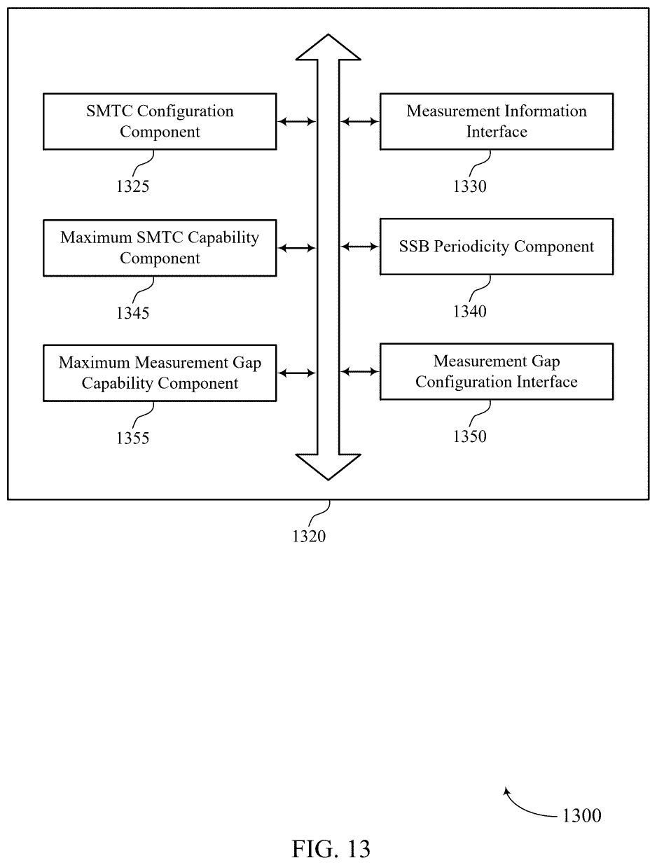

FIG. 13 shows a block diagram 1300 of a communications manager 1320 that supports neighboring cell measurement configurations in non-terrestrial networks in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of neighboring cell measurement configurations in non-terrestrial networks as described herein. For example, the communications manager 1320 may include an SMTC configuration component 1325, a measurement information interface 1330, an SSB periodicity component 1340, a maximum SMTC capability component 1345, a measurement gap configuration interface 1350, a maximum measurement gap capability component 1355, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The SMTC configuration component 1325 is capable of, configured to, or operable to support a means for transmitting, via a serving cell, first information indicative of a set of multiple measurement timing configuration windows for measurement, by a second network entity, of neighbor cell synchronization signal blocks (SSBs) that are collectively associated with a set of multiple SSB groups, where the set of multiple SSB groups is collectively associated with one or more non-terrestrial network (NTN) network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window. The measurement information interface 1330 is capable of, configured to, or operable to support a means for receiving, via the serving cell, measurement information that is based on at least one measurement of the first SSB or the second SSB.

In some examples, the first information includes a common indication that indicates the set of multiple measurement timing configuration windows.

In some examples, the SSB periodicity component 1340 is capable of, configured to, or operable to support a means for transmitting an indication of a periodicity of SSB transmission, where the periodicity is applicable to periodic transmissions of the first SSB and periodic transmissions of the second SSB, and where the periodic transmissions of the second SSB are temporally offset from the periodic transmissions of the first SSB.

In some examples, to support transmitting the indication of the periodicity, the SSB periodicity component 1340 is capable of, configured to, or operable to support a means for transmitting the indication as part of the first information that is indicative of the set of multiple measurement timing configuration windows.

In some examples, to support transmitting the indication of the periodicity, the SSB periodicity component 1340 is capable of, configured to, or operable to support a means for transmitting mobility configuration information that includes the indication of the periodicity.

In some examples, the indication of the periodicity is a parameter in a measurement object information element (IE), in an intra-frequency cell reselection information field in a system information block of a first type, or in an inter-frequency carrier frequency information field in a system information block of a second type.

In some examples, a first indication of a first subset of measurement timing configuration windows of the set of multiple measurement timing configuration windows, where the first subset of measurement timing configuration windows includes the first measurement timing configuration window and is associated with the first SSB group. In some examples, a second indication of a second subset of measurement timing configuration windows of the set of multiple measurement timing configuration windows, where the second subset of measurement timing configuration windows includes the second measurement timing configuration window and is associated with the second SSB group.

In some examples, a first periodicity of the first subset of measurement timing configuration windows is equal to a first periodicity of first SSBs associated with the first SSB group, and where a second periodicity of the second subset of measurement timing configuration windows is equal to a second periodicity of second SSBs associated with the second SSB group.

In some examples, the first subset of measurement timing configuration windows is associated with the first SSB group and a first NTN network entity of the one or more NTN network entities and the second subset of measurement timing configuration windows is associated with the second SSB group and a second NTN network entity of the one or more NTN network entities.

In some examples, the first subset of measurement timing configuration windows is associated with the first SSB group and a first NTN network entity of the one or more NTN network entities, and where the second subset of measurement timing configuration windows is associated with the second SSB group and the first NTN network entity.

In some examples, the maximum SMTC capability component 1345 is capable of, configured to, or operable to support a means for receiving an indication of a maximum quantity of different subsets of measurement timing configuration windows that the second network entity is capable of supporting for an NTN network entity.

In some examples, the measurement gap configuration interface 1350 is capable of, configured to, or operable to support a means for transmit second information indicative of a set of multiple measurement gaps for inter-frequency measurement of neighbor cells of a first NTN network entity, where each measurement timing configuration window of the set of multiple measurement timing configuration windows at least partially overlaps with a respective measurement gap of the set of multiple measurement gaps.

In some examples, a common indication of the set of multiple measurement gaps for inter-frequency measurement of neighbor cells, where the set of multiple measurement gaps includes a first measurement gap that overlaps with the first measurement timing configuration window and a second measurement gap that overlaps with the second measurement timing configuration window.

In some examples, a first indication of a first subset of measurement gaps of the set of multiple measurement gaps for inter-frequency measurement of neighbor cells, where the first subset of measurement gaps includes a first measurement gap that overlaps with the first measurement timing configuration window. In some examples, a second indication of a second subset of measurement gaps of the set of multiple measurement gaps for inter-frequency measurement of neighbor cells, where the second subset of measurement gaps includes a second measurement gap that overlaps with the second measurement timing configuration window.

In some examples, the maximum measurement gap capability component 1355 is capable of, configured to, or operable to support a means for receiving an indication of a maximum quantity of different subsets of measurement gaps that the second network entity is capable of supporting for an NTN network entity.

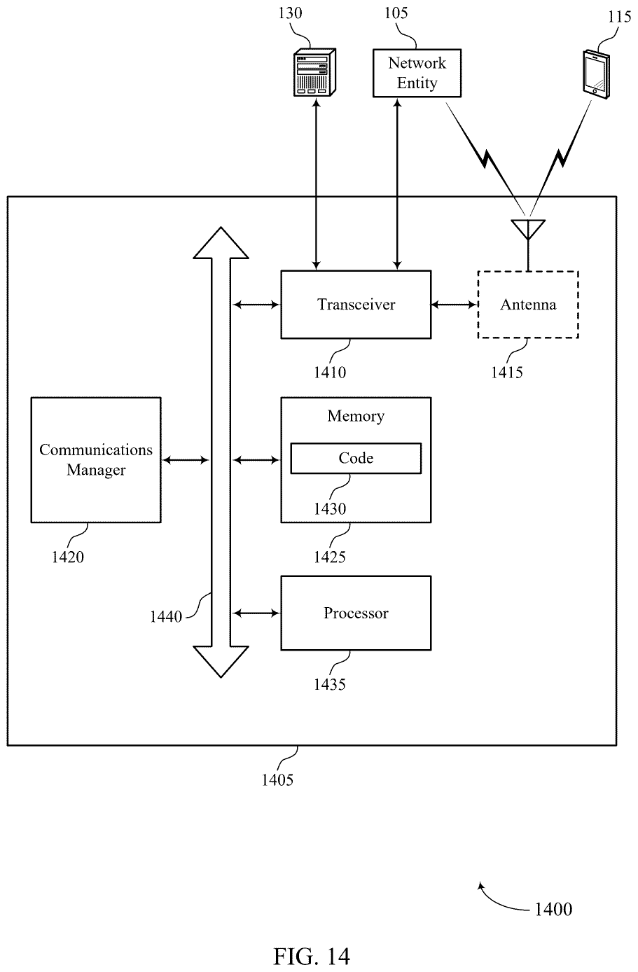

FIG. 14 shows a diagram of a system 1400 including a device 1405 that supports neighboring cell measurement configurations in non-terrestrial networks in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting neighboring cell measurement configurations in non-terrestrial networks). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communication network technology to provide communication between network entities 105.

The communications manager 1420 may support wireless communication in accordance with examples as disclosed herein. For example, the communications manager 1420 is capable of, configured to, or operable to support a means for transmitting, via a serving cell, first information indicative of a set of multiple measurement timing configuration windows for measurement, by a second network entity, of neighbor cell synchronization signal blocks (SSBs) that are collectively associated with a set of multiple SSB groups, where the set of multiple SSB groups is collectively associated with one or more non-terrestrial network (NTN) network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window. The communications manager 1420 is capable of, configured to, or operable to support a means for receiving, via the serving cell, measurement information that is based on at least one measurement of the first SSB or the second SSB.

By including or configuring the communications manager 1420 in accordance with examples as described herein, the device 1405 may support techniques for reduced power consumption and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of neighboring cell measurement configurations in non-terrestrial networks as described herein, or the at least one processor 1435 and the at least one memory 1425 may be otherwise configured to, individually or collectively, perform or support such operations.

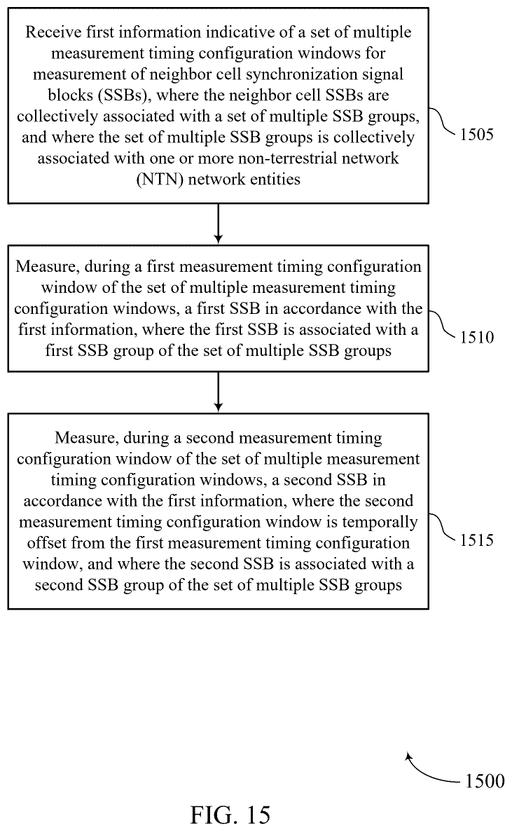

FIG. 15 shows a flowchart illustrating a method 1500 that supports neighboring cell measurement configurations in non-terrestrial networks in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities. The operations of 1505 may be performed in accordance with examples as disclosed herein. In some examples, aspects of the operations of 1505 may be performed by an SMTC configuration interface 925 as described with reference to FIG. 9.

At 1510, the method may include measuring, during a first measurement timing configuration window of the set of multiple measurement timing configuration windows, a first SSB in accordance with the first information, where the first SSB is associated with a first SSB group of the set of multiple SSB groups. The operations of 1510 may be performed in accordance with examples as disclosed herein. In some examples, aspects of the operations of 1510 may be performed by a first SSB measurement component 930 as described with reference to FIG. 9.

At 1515, the method may include measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups. The operations of 1515 may be performed in accordance with examples as disclosed herein. In some examples, aspects of the operations of 1515 may be performed by a second SSB measurement component 935 as described with reference to FIG. 9.

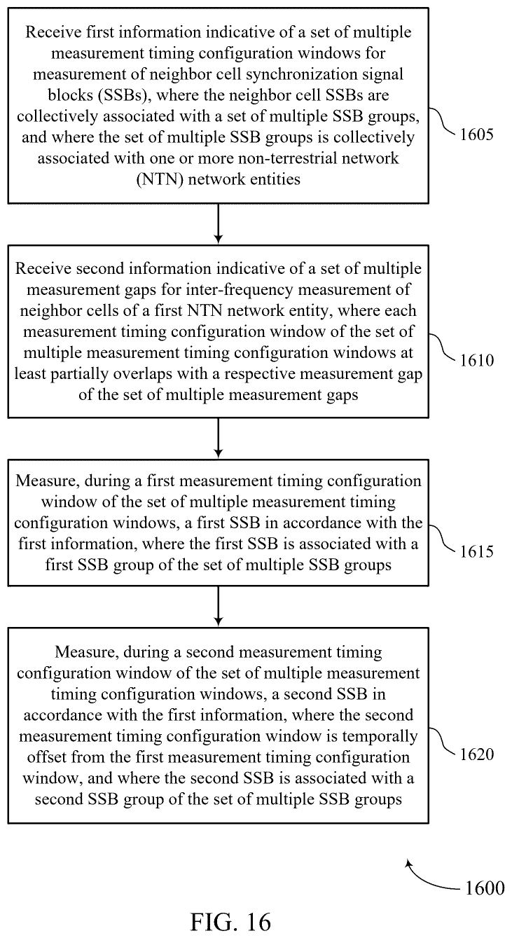

FIG. 16 shows a flowchart illustrating a method 1600 that supports neighboring cell measurement configurations in non-terrestrial networks in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving first information indicative of a set of multiple measurement timing configuration windows for measurement of neighbor cell synchronization signal blocks (SSBs), where the neighbor cell SSBs are collectively associated with a set of multiple SSB groups, and where the set of multiple SSB groups is collectively associated with one or more non-terrestrial network (NTN) network entities. The operations of 1605 may be performed in accordance with examples as disclosed herein. In some examples, aspects of the operations of 1605 may be performed by an SMTC configuration interface 925 as described with reference to FIG. 9.

At 1610, the method may include receiving second information indicative of a set of multiple measurement gaps for inter-frequency measurement of neighbor cells of a first NTN network entity, where each measurement timing configuration window of the set of multiple measurement timing configuration windows at least partially overlaps with a respective measurement gap of the set of multiple measurement gaps. The operations of 1610 may be performed in accordance with examples as disclosed herein. In some examples, aspects of the operations of 1610 may be performed by a measurement gap configuration interface 960 as described with reference to FIG. 9.

At 1615, the method may include measuring, during a first measurement timing configuration window of the set of multiple measurement timing configuration windows, a first SSB in accordance with the first information, where the first SSB is associated with a first SSB group of the set of multiple SSB groups. The operations of 1615 may be performed in accordance with examples as disclosed herein. In some examples, aspects of the operations of 1615 may be performed by a first SSB measurement component 930 as described with reference to FIG. 9.

At 1620, the method may include measuring, during a second measurement timing configuration window of the set of multiple measurement timing configuration windows, a second SSB in accordance with the first information, where the second measurement timing configuration window is temporally offset from the first measurement timing configuration window, and where the second SSB is associated with a second SSB group of the set of multiple SSB groups. The operations of 1620 may be performed in accordance with examples as disclosed herein. In some examples, aspects of the operations of 1620 may be performed by a second SSB measurement component 935 as described with reference to FIG. 9.

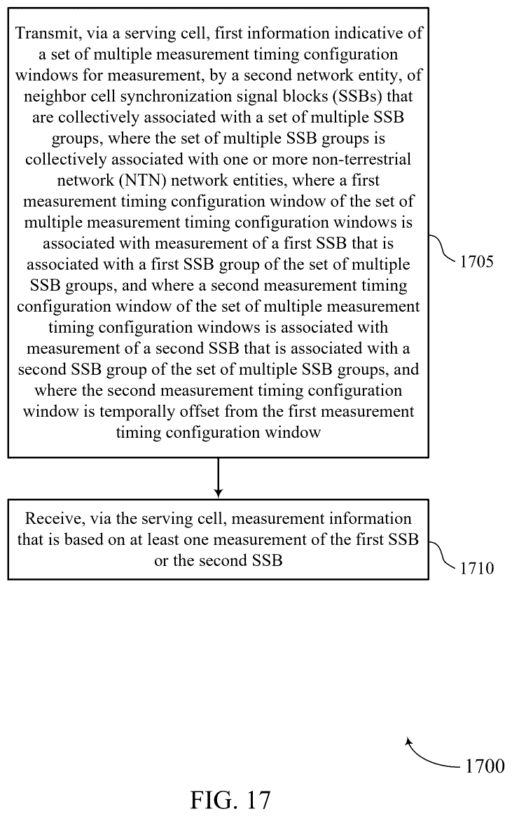

FIG. 17 shows a flowchart illustrating a method 1700 that supports neighboring cell measurement configurations in non-terrestrial networks in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, via a serving cell, first information indicative of a set of multiple measurement timing configuration windows for measurement, by a second network entity, of neighbor cell synchronization signal blocks (SSBs) that are collectively associated with a set of multiple SSB groups, where the set of multiple SSB groups is collectively associated with one or more non-terrestrial network (NTN) network entities, where a first measurement timing configuration window of the set of multiple measurement timing configuration windows is associated with measurement of a first SSB that is associated with a first SSB group of the set of multiple SSB groups, and where a second measurement timing configuration window of the set of multiple measurement timing configuration windows is associated with measurement of a second SSB that is associated with a second SSB group of the set of multiple SSB groups, and where the second measurement timing configuration window is temporally offset from the first measurement timing configuration window. The operations of 1705 may be performed in accordance with examples as disclosed herein. In some examples, aspects of the operations of 1705 may be performed by an SMTC configuration component 1325 as described with reference to FIG. 13.

At 1710, the method may include receiving, via the serving cell, measurement information that is based on at least one measurement of the first SSB or the second SSB. The operations of 1710 may be performed in accordance with examples as disclosed herein. In some examples, aspects of the operations of 1710 may be performed by a measurement information interface 1330 as described with reference to FIG. 13.

The following provides an overview of aspects of the present disclosure:
Aspect 1: A method for wireless communication at a first network entity, comprising: receiving first information indicative of a plurality of measurement timing configuration windows for measurement of neighbor cell synchronization signal blocks (SSBs), wherein the neighbor cell SSBs are collectively associated with a plurality of SSB groups, and wherein the plurality of SSB groups is collectively associated with one or more non-terrestrial network (NTN) network entities; measuring, during a first measurement timing configuration window of the plurality of measurement timing configuration windows, a first SSB in accordance with the first information, wherein the first SSB is associated with a first SSB group of the plurality of SSB groups; and measuring, during a second measurement timing configuration window of the plurality of measurement timing configuration windows, a second SSB in accordance with the first information, wherein the second measurement timing configuration window is temporally offset from the first measurement timing configuration window, and wherein the second SSB is associated with a second SSB group of the plurality of SSB groups.
Aspect 2: The method of aspect 1, wherein the first information includes a common indication that indicates the plurality of measurement timing configuration windows.
Aspect 3: The method of any of aspects 1 through 2, wherein receiving an indication of a periodicity of SSB transmission, wherein the periodicity is applicable to periodic transmissions of the first SSB and periodic transmissions of the second SSB, wherein the periodic transmissions of the second SSB are temporally offset from the periodic transmissions of the first SSB, wherein measuring the first SSB comprises; measuring the first SSB during a first subset of measurement timing configuration windows of the plurality of measurement timing configuration windows based on the periodicity, wherein the first subset of measurement timing configuration windows includes the first measurement timing configuration window, and wherein measuring the SSB comprises; and measuring the second SSB during a second subset of measurement timing configuration windows of the plurality of measurement timing configuration windows based on the periodicity, wherein the second subset of measurement timing configuration windows includes the second measurement timing configuration window.
Aspect 4: The method of aspect 3, wherein receiving the indication of the periodicity comprises: receiving the indication as part of the first information that is indicative of the plurality of measurement timing configuration windows.
Aspect 5: The method of any of aspects 3 through 4, wherein receiving the indication of the periodicity comprises: receiving mobility configuration information that includes the indication of the periodicity.
Aspect 6: The method of aspect 5, wherein the indication of the periodicity is a parameter in a measurement object information element (IE), in an intra-frequency cell reselection information field in a system information block of a first type, or in an inter-frequency carrier frequency information field in a system information block of a second type.
Aspect 7: The method of aspect 1, wherein the first information includes a first indication of a first subset of measurement timing configuration windows of the plurality of measurement timing configuration windows, wherein the first subset of measurement timing configuration windows includes the first measurement timing configuration window and is associated with the first SSB group; and a second indication of a second subset of measurement timing configuration windows of the plurality of measurement timing configuration windows, wherein the second subset of measurement timing configuration windows includes the second measurement timing configuration window and is associated with the second SSB group.
Aspect 8: The method of aspect 7, wherein a first periodicity of the first subset of measurement timing configuration windows is equal to a first periodicity of first SSBs associated with the first SSB group, and wherein a second periodicity of the second subset of measurement timing configuration windows is equal to a second periodicity of second SSBs associated with the second SSB group.
Aspect 9: The method of any of aspects 7 through 8, wherein the first subset of measurement timing configuration windows is associated with the first SSB group and a first NTN network entity of the one or more NTN network entities and the second subset of measurement timing configuration windows is associated with the second SSB group and a second NTN network entity of the one or more NTN network entities.
Aspect 10: The method of any of aspects 7 through 8, wherein the first subset of measurement timing configuration windows is associated with the first SSB group and a first NTN network entity of the one or more NTN network entities, and wherein the second subset of measurement timing configuration windows is associated with the second SSB group and the first NTN network entity.
Aspect 11: The method of any of aspects 1 through 10, further comprising: transmitting an indication of a maximum quantity of different subsets of measurement timing configuration windows that the first network entity is capable of supporting for an NTN network entity.

Aspect 12: The method of any of aspects 1 through 11, further comprising: receiving second information indicative of a plurality of measurement gaps for inter-frequency measurement of neighbor cells of a first NTN network entity, wherein each measurement timing configuration window of the plurality of measurement timing configuration windows at least partially overlaps with a respective measurement gap of the plurality of measurement gaps.

Aspect 13: The method of aspect 12, wherein the second information includes a common indication of the plurality of measurement gaps for inter-frequency measurement of neighbor cells of the first NTN network entity, and wherein the plurality of measurement gaps indicated by the common indication includes a first measurement gap that overlaps with the first measurement timing configuration window and a second measurement gap that overlaps with the second measurement timing configuration window.

Aspect 14: The method of aspect 12, wherein the second information includes a first indication of a first subset of measurement gaps of the plurality of measurement gaps for inter-frequency measurement of neighbor cells of the first NTN network entity, wherein the first subset of measurement gaps includes a first measurement gap that overlaps with the first measurement timing configuration window; and a second indication of a second subset of measurement gaps of the plurality of measurement gaps for inter-frequency measurement of neighbor cells of the first NTN network entity, wherein the second subset of measurement gaps includes a second measurement gap that overlaps with the second measurement timing configuration window.

Aspect 15: The method of any of aspects 1 through 14, further comprising: transmitting an indication of a maximum quantity of different subsets of measurement gaps that the first network entity is capable of supporting for an NTN network entity.

Aspect 16: A method for wireless communication at a first network entity, comprising: transmitting, via a serving cell, first information indicative of a plurality of measurement timing configuration windows for measurement, by a second network entity, of neighbor cell synchronization signal blocks (SSBs) that are collectively associated with a plurality of SSB groups, wherein the plurality of SSB groups is collectively associated with one or more non-terrestrial network (NTN) network entities, wherein a first measurement timing configuration window of the plurality of measurement timing configuration windows is associated with measurement of a first SSB that is associated with a first SSB group of the plurality of SSB groups, and wherein a second measurement timing configuration window of the plurality of measurement timing configuration windows is associated with measurement of a second SSB that is associated with a second SSB group of the plurality of SSB groups, and wherein the second measurement timing configuration window is temporally offset from the first measurement timing configuration window; and receiving, via the serving cell, measurement information that is based on at least one measurement of the first SSB or the second SSB.

Aspect 17: The method of aspect 16, wherein the first information includes a common indication that indicates the plurality of measurement timing configuration windows.

Aspect 18: The method of any of aspects 16 through 17, further comprising: transmitting an indication of a periodicity of SSB transmission, wherein the periodicity is applicable to periodic transmissions of the first SSB and periodic transmissions of the second SSB, and wherein the periodic transmissions of the second SSB are temporally offset from the periodic transmissions of the first SSB.

Aspect 19: The method of aspect 18, wherein transmitting the indication of the periodicity comprises: transmitting the indication as part of the first information that is indicative of the plurality of measurement timing configuration windows.

Aspect 20: The method of any of aspects 18 through 19, wherein transmitting the indication of the periodicity comprises: transmitting mobility configuration information that includes the indication of the periodicity.

Aspect 21: The method of aspect 20, wherein the indication of the periodicity is a parameter in a measurement object information element (IE), in an intra-frequency cell reselection information field in a system information block of a first type, or in an inter-frequency carrier frequency information field in a system information block of a second type.

Aspect 22: The method of aspect 16, wherein the first information includes a first indication of a first subset of measurement timing configuration windows of the plurality of measurement timing configuration windows, wherein the first subset of measurement timing configuration windows includes the first measurement timing configuration window and is associated with the first SSB group; and a second indication of a second subset of measurement timing configuration windows of the plurality of measurement timing configuration windows, wherein the second subset of measurement timing configuration windows includes the second measurement timing configuration window and is associated with the second SSB group.

Aspect 23: The method of aspect 22, wherein a first periodicity of the first subset of measurement timing configuration windows is equal to a first periodicity of first SSBs associated with the first SSB group, and wherein a second periodicity of the second subset of measurement timing configuration windows is equal to a second periodicity of second SSBs associated with the second SSB group.

Aspect 24: The method of any of aspects 22 through 23, wherein the first subset of measurement timing configuration windows is associated with the first SSB group and a first NTN network entity of the one or more NTN network entities and the second subset of measurement timing configuration windows is associated with the second SSB group and a second NTN network entity of the one or more NTN network entities.

Aspect 25: The method any of aspects 22 through 23, wherein the first subset of measurement timing configuration windows is associated with the first SSB group and a first NTN network entity of the one or more NTN network entities, and wherein the second subset of measurement timing configuration windows is associated with the second SSB group and the first NTN network entity.

Aspect 26: The method of any of aspects 16 through 25, further comprising: receiving an indication of a maximum quantity of different subsets of measurement timing configuration windows that the second network entity is capable of supporting for an NTN network entity.

Aspect 27: The method of any of aspects 16 through 26, further comprising: transmit second information indicative of a plurality of measurement gaps for inter-frequency measurement of neighbor cells of a first NTN network entity, wherein each measurement timing configuration window of the plurality of measurement timing configuration windows at least partially overlaps with a respective measurement gap of the plurality of measurement gaps.

Aspect 28: The method of aspect 27, wherein the second information includes a common indication of the plurality of measurement gaps for inter-frequency measurement of neighbor cells, wherein the plurality of measurement gaps includes a first measurement gap that overlaps with the first measurement timing configuration window and a second measurement gap that overlaps with the second measurement timing configuration window.

Aspect 29: The method of aspect 27, wherein the second information includes a first indication of a first subset of measurement gaps of the plurality of measurement gaps for inter-frequency measurement of neighbor cells, wherein the first subset of measurement gaps includes a first measurement gap that overlaps with the first measurement timing configuration window; and a second indication of a second subset of measurement gaps of the plurality of measurement gaps for inter-frequency measurement of neighbor cells, wherein the second subset of measurement gaps includes a second measurement gap that overlaps with the second measurement timing configuration window.

Aspect 30: The method of any of aspects 16 through 29, further comprising: receiving an indication of a maximum quantity of different subsets of measurement gaps that the second network entity is capable of supporting for an NTN network entity.

Aspect 31: A first network entity for wireless communication, comprising a processing system configured to perform a method of any of aspects 1 through 15.

Aspect 32: A first network entity for wireless communication, comprising at least one means for performing a method of any of aspects 1 through 15.

Aspect 33: A non-transitory computer-readable medium having code for wireless communication stored thereon that, when executed by a first network entity, causes the first network entity to perform a method of any of aspects 1 through 15.

Aspect 34: A first network entity for wireless communication, comprising a processing system configured to perform a method of any of aspects 16 through 30.

Aspect 35: A first network entity for wireless communication, comprising at least one means for performing a method of any of aspects 16 through 30.

Aspect 36 A non-transitory computer-readable medium having code for wireless communication stored thereon that, when executed by a first network entity, causes the first network entity to perform a method of any of aspects 16 through 30.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
a processing system configured to:
receive first information indicative of a plurality of measurement timing configuration windows for measurement of neighbor cell synchronization signal blocks (SSBs), wherein the neighbor cell SSBs are collectively associated with a plurality of SSB groups, and wherein the plurality of SSB groups is collectively associated with one or more non-terrestrial network (NTN) network entities;
measure, during a first measurement timing configuration window of the plurality of measurement timing configuration windows, a first SSB in accordance with the first information, wherein the first SSB is associated with a first SSB group of the plurality of SSB groups; and
measure, during a second measurement timing configuration window of the plurality of measurement timing configuration windows, a second SSB in accordance with the first information, wherein the second measurement timing configuration window is temporally offset from the first measurement timing configuration window, and wherein the second SSB is associated with a second SSB group of the plurality of SSB groups.

2. The first network entity of claim 1, wherein the first information includes a common indication that indicates the plurality of measurement timing configuration windows.

3. The first network entity of claim 1, wherein the processing system is configured to:
receive an indication of a periodicity of SSB transmission, wherein the periodicity is applicable to periodic transmissions of the first SSB and periodic transmissions of the second SSB, wherein the periodic transmissions of the second SSB are temporally offset from the periodic transmissions of the first SSB, wherein to measure the first SSB, the processing system is configured to:
measure the first SSB during a first subset of measurement timing configuration windows of the plurality of measurement timing configuration windows based on the periodicity, wherein the first subset of measurement timing configuration windows includes the first measurement timing configuration window, and wherein to measure the second SSB, the processing system is configured to:
measure the second SSB during a second subset of measurement timing configuration windows of the plurality of measurement timing configuration windows based on the periodicity, wherein the second subset of measurement timing configuration windows includes the second measurement timing configuration window.

4. The first network entity of claim 3, wherein, to receive the indication of the periodicity, the processing system is configured to:
receive the indication as part of the first information that is indicative of the plurality of measurement timing configuration windows.

5. The first network entity of claim 3, wherein, to receive the indication of the periodicity, the processing system is configured to:
receive mobility configuration information that includes the indication of the periodicity.

6. The first network entity of claim 5, wherein the indication of the periodicity is a parameter in a measurement object information element (IE), in an intra-frequency cell reselection information field in a system information block of a first type, or in an inter-frequency carrier frequency information field in a system information block of a second type.

7. The first network entity of claim 1, wherein the first information includes:
a first indication of a first subset of measurement timing configuration windows of the plurality of measurement timing configuration windows, wherein the first subset of measurement timing configuration windows includes the first measurement timing configuration window and is associated with the first SSB group, and
a second indication of a second subset of measurement timing configuration windows of the plurality of measurement timing configuration windows, wherein the second subset of measurement timing configuration windows includes the second measurement timing configuration window and is associated with the second SSB group.

8. The first network entity of claim 7, wherein a first periodicity of the first subset of measurement timing configuration windows is equal to a first periodicity of first SSBs associated with the first SSB group, and wherein a second periodicity of the second subset of measurement timing configuration windows is equal to a second periodicity of second SSBs associated with the second SSB group.

9. The first network entity of claim 7, wherein the first subset of measurement timing configuration windows is associated with the first SSB group and a first NTN network entity of the one or more NTN network entities and the second subset of measurement timing configuration windows is associated with the second SSB group and a second NTN network entity of the one or more NTN network entities.

10. The first network entity of claim 7, wherein the first subset of measurement timing configuration windows is associated with the first SSB group and a first NTN network entity of the one or more NTN network entities, and wherein the second subset of measurement timing configuration windows is associated with the second SSB group and the first NTN network entity.

11. The first network entity of claim 7, wherein the processing system is configured to:
transmit an indication of a maximum quantity of different subsets of measurement timing configuration windows that the first network entity is capable of supporting for an NTN network entity.

12. The first network entity of claim 1, wherein the processing system is configured to:
receive second information indicative of a plurality of measurement gaps for inter-frequency measurement of neighbor cells of a first NTN network entity, wherein each measurement timing configuration window of the plurality of measurement timing configuration windows at least partially overlaps with a respective measurement gap of the plurality of measurement gaps.

13. The first network entity of claim 12, wherein the second information includes a common indication of the plurality of measurement gaps for inter-frequency measurement of neighbor cells of the first NTN network entity, and wherein the plurality of measurement gaps indicated by the common indication includes a first measurement gap that overlaps with the first measurement timing configuration window and a second measurement gap that overlaps with the second measurement timing configuration window.

14. The first network entity of claim 12, wherein the second information includes:
a first indication of a first subset of measurement gaps of the plurality of measurement gaps for inter-frequency measurement of neighbor cells of the first NTN network entity, wherein the first subset of measurement gaps includes a first measurement gap that overlaps with the first measurement timing configuration window, and
a second indication of a second subset of measurement gaps of the plurality of measurement gaps for inter-frequency measurement of neighbor cells of the first NTN network entity, wherein the second subset of measurement gaps includes a second measurement gap that overlaps with the second measurement timing configuration window.

15. The first network entity of claim 14, wherein the processing system is configured to:
transmit an indication of a maximum quantity of different subsets of measurement gaps that the first network entity is capable of supporting for an NTN network entity.

16. A method of wireless communication performed by a first network entity, comprising:
receiving first information indicative of a plurality of measurement timing configuration windows for measurement of neighbor cell synchronization signal blocks (SSBs), wherein the neighbor cell SSBs are collectively associated with a plurality of SSB groups, and wherein the plurality of SSB groups is collectively associated with one or more non-terrestrial network (NTN) network entities;
measuring, during a first measurement timing configuration window of the plurality of measurement timing configuration windows, a first SSB in accordance with the first information, wherein the first SSB is associated with a first SSB group of the plurality of SSB groups; and
measuring, during a second measurement timing configuration window of the plurality of measurement timing configuration windows, a second SSB in accordance with the first information, wherein the second measurement timing configuration window is temporally offset from the first measurement timing configuration window, and wherein the second SSB is associated with a second SSB group of the plurality of SSB groups.

17. The method of claim 16, wherein the first information includes a common indication that indicates the plurality of measurement timing configuration windows.

18. The method of claim 16, wherein the first information includes:
a first indication of a first subset of measurement timing configuration windows of the plurality of measurement timing configuration windows, wherein the first subset of measurement timing configuration windows includes the first measurement timing configuration window and is associated with the first SSB group;
and a second indication of a second subset of measurement timing configuration windows of the plurality of measurement timing configuration windows, wherein the second subset of measurement timing configuration windows includes the second measurement timing configuration window and is associated with the second SSB group.

19. The method of claim 16, further comprising:
receiving second information indicative of a plurality of measurement gaps for inter-frequency measurement of neighbor cells of a first NTN network entity, wherein each measurement timing configuration window of the plurality of measurement timing configuration windows at least partially overlaps with a respective measurement gap of the plurality of measurement gaps.

20. A first network entity for wireless communication, comprising:
means for receiving first information indicative of a plurality of measurement timing configuration windows for measurement of neighbor cell synchronization signal blocks (SSBs), wherein the neighbor cell SSBs are collectively associated with a plurality of SSB groups, and wherein the plurality of SSB groups is collectively associated with one or more non-terrestrial network (NTN) network entities;
means for measuring, during a first measurement timing configuration window of the plurality of measurement timing configuration windows, a first SSB in accordance with the first information, wherein the first SSB is associated with a first SSB group of the plurality of SSB groups; and
means for measuring, during a second measurement timing configuration window of the plurality of measurement timing configuration windows, a second SSB in accordance with the first information, wherein the second measurement timing configuration window is temporally offset from the first measurement timing configuration window, and wherein the second SSB is associated with a second SSB group of the plurality of SSB groups.
